(19) United States
(12) Patent Application Publication
(10) Pub. No.: US 2023/0093055 A1
(43) Pub. Date: Mar. 23, 2023

(54) FOLDING MASSAGE TABLE WITH ATMOSPHERE LAMP

(71) Applicant: Jiangsu Mingteng Health Products Co., Ltd, Yancheng (CN)

(72) Inventor: Chuankui Du, Jinshan (CN)

(73) Assignee: Jiangsu Mingteng Health Products Co., Ltd, Yancheng (CN)

(21) Appl. No.: 18/073,578

(22) Filed: Dec. 2, 2022

(30) Foreign Application Priority Data
Sep. 15, 2022 (CN) 202222450502.7

(51) Int. Cl. A61G 13/00; A61G 13/10; A61H 37/00

(52) U.S. Cl. CPC A61G 13/009; A61G 13/105; A61H 37/00

(57) ABSTRACT

The present disclosure is applicable to the technical field of massage apparatuses, and provides a folding massage table with an atmosphere lamp. The folding massage table includes a rigid planner surface, a cushioned pad, and an upholstery cover. The rigid planner surface is divided into a left rigid planner surface and a right rigid planner surface, and the two rigid planner surfaces are connected through a hinge. The rigid planner surfaces can inwards rotate around the hinge and be folded. The cushioned pad is divided into a left part and a right part, and the two cushioned pads are fixedly mounted on the left and right rigid planner surfaces respectively. The upholstery cover is upholstered on the left and right cushioned pads.

### TECHNICAL FIELD

The present disclosure relates to the technical field of massage apparatuses, in particular, to a folding massage table with an atmosphere lamp.

### BACKGROUND

Existing folding massage tables have complicated folding mechanisms. Most manufacturers have a carpentry production thinking They often pay more attention to the structural fastness and comfort of a folding massage table, but ignore the atmosphere, resulting in a changeless style of massage tables in the folding massage table market for many years, and making users lack a better massage experience. Most massage places are decorated luxuriously, with dark and soft light. Some atmosphere lamps will be added in furniture or decoration of a massage place to create a reassuring and relaxing atmosphere. Folding massage tables are mostly used when masseuses give a home massage to clients. There is no professional atmosphere light in the house of a client, and the client cannot have a comfortable feeling as in a massage place. Therefore, it is necessary to mount a light source under a folding portable massage table.

### SUMMARY

An embodiment of the present disclosure is to provide a folding massage table with an atmosphere lamp, and aims to bring a more comfortable, relaxed and high-end massage atmosphere for a client who experiences a home massage service.

The present disclosure is achieved by a folding massage table with an atmosphere lamp. The folding massage table with the atmosphere lamp includes:

a rigid planner surface, a cushioned pad, and an upholstery cover; the rigid planner surface is divided into a left rigid planner surface and a right rigid planner surface, and a hinge is mounted between the two rigid planner surfaces; the rigid planner surfaces may inwards rotate around the hinge and be folded; the cushioned pad is divided into a left part and a right part, which are fixedly mounted on the left and right rigid planner surfaces respectively; and the soft upholstery cover is upholstered on the left and right cushioned pads respectively.

The folding massage table further includes table legs, long leg supports and short leg supports; the table legs are rotatably mounted to two left side corners of the left rigid planner surface and two right side corners of the right rigid planner surface, so that four table legs are away from each other; one end of each long leg support is rotatably connected to positions of the left and right rigid planner surfaces close to the hinge; the other end of each long leg support is rotatably connected to one end of one short leg support; and the other end of each short leg support is rotatably connected to a lower part of one table leg.

The folding massage table further includes a cable system; the cable system is provided with multiple mounting points, mounted to four corners of portable massage table and the connection parts of long leg supports and short leg supports. When the table opens up, the cable system is tensed, the long and short leg supports are fixed to support the central area of folding massage table, and the cable system can ensure the central area of the portable massage table will not collapse. When the folding massage table is folded, the cable system is in a slack and soft state for convenient folding.

The folding massage table further includes a light-emitting assembly; and the light-emitting assembly includes a light-emitting unit, a wire, a control assembly and an adapter.

In a further technical solution, at least two light-emitting units are arranged, each of which is at least arranged below each of the left and right rigid planner surfaces; and the light-emitting units emit light when being powered on.

In a further technical solution, each light-emitting unit includes a light strip and a fixing member; the fixing member is fixedly connected to a lower part of the rigid planner surface; and the fixing member clamps the light strip.

In a further technical solution, a plurality of light-emitting units are connected through wires, and each wire is a soft wire.

In a further technical solution, a control assembly, wherein a circuit board is mounted inside the control assembly; and the circuit board is connected to the light strip through a wire.

In a further technical solution, the circuit board of the control assembly controls a light-emitting brightness and a light-emitting color of the light strip by means of controlling power supplying.

In a further technical solution, the control assembly is provided with a control unit, and the control unit is connected to the circuit board; and the control unit controls the circuit board to supply power to the light strip.

In a further technical solution, the folding massage table further includes a power adapter; the power adapter may be connected to an external power socket and converts a voltage of an external power supply of 110-230 V into a safe voltage lower than 36 V; and the power adapter is connected to the circuit board in the control assembly through a wire.

In a further technical solution, the table legs below the rigid planner surface may rotate towards the hinge around joint parts of the table legs and the rigid planner surface; the short leg supports may rotate around joint parts of the short leg supports and the table legs; the long leg supports and the short leg supports rotate around joint parts thereof; the long leg supports rotate around joint parts of the long leg supports and the rigid planner surface, so that the table legs, the long leg supports and the short leg supports all rotate to be folded to a position parallel and close to a bottom of the rigid planner surface by means of the above rotating manner; and the left and right rigid planner surfaces are rotatably folded through the hinge, so that the folding massage table with the atmosphere lamp is folded to be a leather suitcase form.

Compared with the prior art, the present disclosure has the beneficial effects:

According to the folding massage table with an atmosphere lamp provided according to the present disclosure, the light-emitting units are mounted below the rigid planner surface of the folding massage table. A user turns on the light strips of the light-emitting units through the control assembly, and controls the light-emitting brightness and the light-emitting color of the light strips through the control assembly, so that a client experiences a warm, comfortable, relaxed and high-end massage atmosphere as in a professional massage place.

### BRIEF DESCRIPTION OF THE DRAWINGS

FIG. 1 is a flat view of a folding massage table with an atmosphere lamp provided according to an embodiment of the present disclosure;

FIG. 2 is a bottom view of a folding massage table with an atmosphere lamp provided according to an embodiment of the present disclosure;

FIG. 3 is a three-dimensional diagram of a folding massage table with an atmosphere lamp provided according to an embodiment of the present disclosure;

FIG. 4 is a schematic diagram of a light-emitting assembly of a folding massage table with an atmosphere lamp provided according to an embodiment of the present disclosure; and

FIG. 5 is a schematic diagram of a folding effect of a folding massage table with an atmosphere lamp provided according to an embodiment of the present disclosure.

In the drawings: rigid planner surface 1, cushioned pad 2, table leg 3, short leg support 4, long leg support 5, cable system 6, light-emitting unit 7, light strip 8, fixing member 9, wire 10, control assembly 11, circuit board 12, control unit 13, adapter 14, upholstery cover 15, and hinge 16.

### DETAILED DESCRIPTION OF THE EMBODIMENTS

In order to make the objectives, technical solutions and advantages of the present disclosure clearer, the present disclosure is further described in detail below with reference to accompanying drawings and embodiments. It should be understood that the specific embodiments described here are merely to illustrate and explain the present disclosure, and not intended to limit the present disclosure.

Specific implementation of the present disclosure is described in detail below in combination with specific embodiments.

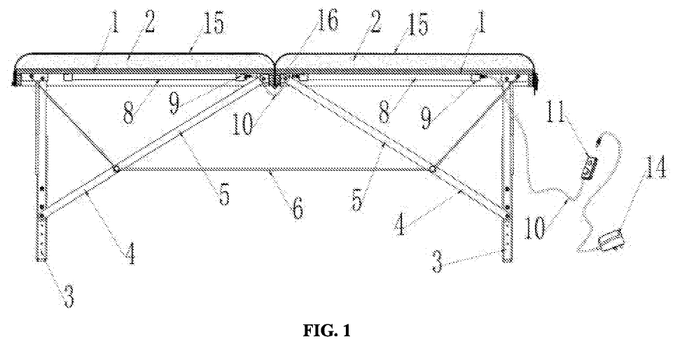

As shown in FIG. 1, a folding massage table with an atmosphere lamp provided according to one embodiment of the present disclosure includes:

a rigid planner surface 1, a cushioned pad 2, and an upholstery cover 15. The rigid planner surface 1 is divided into a left rigid planner surface and a right rigid planner surface. Two hinges 16 are mounted at the connection area of the left and right rigid planner surfaces 1. The left and right rigid planner surfaces 1 may inwards rotate around the hinges 16 and be folded. The cushioned pad 2 is divided into a left part and a right part which are respectively fixedly mounted on the left and right rigid planner surfaces 1. The left and right cushioned pads 2 are respectively upholstered with the soft upholstery cover 15.

As shown in FIG. 1 to FIG. 3, the folding massage table further includes four table legs 3, four long leg supports 5, and four short leg supports 4. One table leg 3 is mounted at each of left and right outer ends of the left and right rigid planner surfaces 1. One end of each long leg support 5 is rotatably connected to positions of the left and right rigid planner surfaces 1 close to the hinge 16. The other end of each long leg support 5 is rotatably connected to one end of one short leg support 4. The other end of each short leg support 4 is rotatably connected to a lower part of one table leg 3.

As shown in FIG. 1 to FIG. 3, the folding massage table further includes a cable system 6. The cable system 6 is divided into two cables 6. Each cable 6 crosses over the left and right rigid planner surfaces 1. Each cable 6 has four mounting points. The mounting points on two ends of each cable 6 are mounted to upper parts of the table legs 3 on both sides of the massage table. Mounting points on the middle area of each cable 6 are mounted to the connection parts of the long leg supports 5 and the short leg supports 4 on both sides of the massage table.

In the embodiment of the present disclosure, when the table opens up, the cable system 6 is tensed, the position and angle of the long leg supports 5 and the short leg supports 4 are fixed to support the central area of the folding massage table, so that the cable system 6 can ensure the central area of portable massage table will not collapse. When the folding massage table is folded, the cable system 6 is in a slack and soft state for convenient folding.

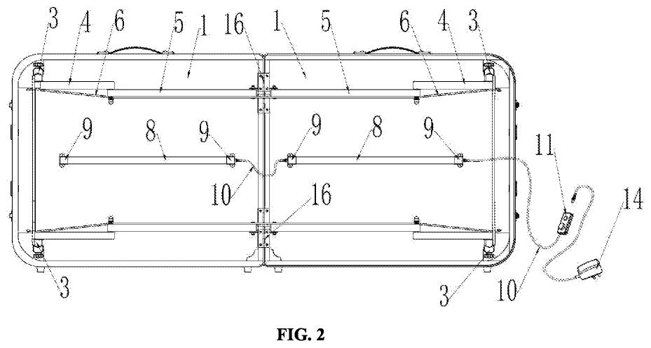

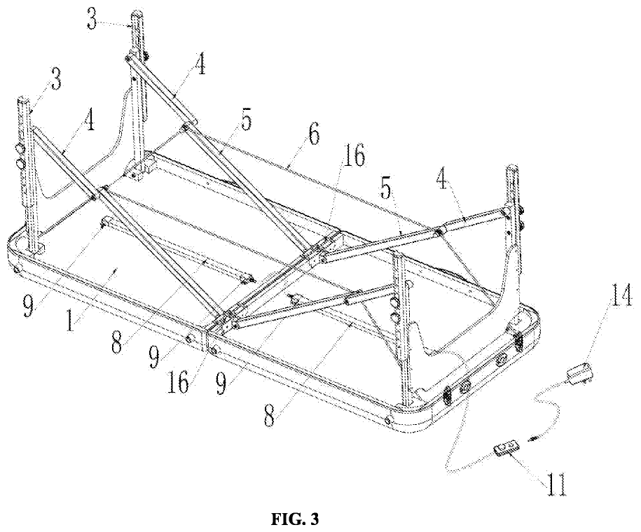

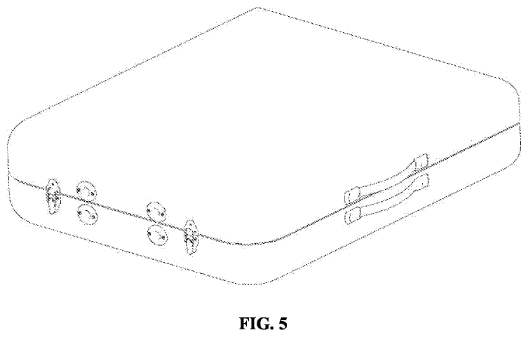

As shown in FIG. 1, FIG. 2, FIG. 3, and FIG. 5, the table legs 3 below the rigid planner surface 1 may rotate towards the hinge 16 around joint parts of the table legs 3 and the rigid planner surface 1. The short leg supports 4 may rotate around joint parts of the short leg supports 4 and the table legs 3. The long leg supports 5 and the short leg supports 4 rotate around joint parts thereof. The long leg supports 5 rotate around joint parts of the long leg supports 5 and the rigid planner surface 1, so that the table legs 3, the long leg supports 5 and the short leg supports 4 all rotate to be folded to a position parallel and close to a bottom of the rigid planner surface 1 by means of the above rotating manner. The left and right rigid planner surfaces 1 are rotatably folded through the hinges 16, so that the folding massage table with the atmosphere lamp is folded to be a leather suitcase form.

As shown in FIG. 1 to FIG. 4, the folding massage table in the present disclosure further includes a light-emitting assembly. The light-emitting assembly includes a light-emitting unit 7, a wire 10, a control assembly 11 and an adapter 14.

As shown in FIG. 1 to FIG. 4, two light emitting units 7 are arranged, which are respectively fixed below the left and right rigid planner surfaces 1. The light emitting units 7 may emit light when being powered on.

As shown in FIG. 1 to FIG. 4, each light emitting unit 7 includes a light strip 8 and a fixing member 9. The fixing member 9 is fixedly connected to a lower part of the rigid planner surface 1. The fixing member 9 clamps the light strip 8.

As shown in FIG. 1 to FIG. 4, the two light-emitting units 7 are connected through the wire 10, and the wire 10 is a soft wire.

In the embodiment of the present disclosure, when the table is folded, the two light-emitting units 7 will not interfere the folding of the rigid planner surface 1 due to the softness of the wire 10.

As shown in FIG. 1 to FIG. 4, the folding massage table further includes a control assembly 11. A circuit board 12 is mounted inside the control assembly 11. The circuit board 12 is connected to the light strip 8 through the wire 10.

In the embodiment of the present disclosure, the circuit board 12 achieves a function of controlling power supplying. The circuit board 12 plays a role of controlling a light-emitting color and a light-emitting brightness of the light strip 8 by means of controlling the power supplying.

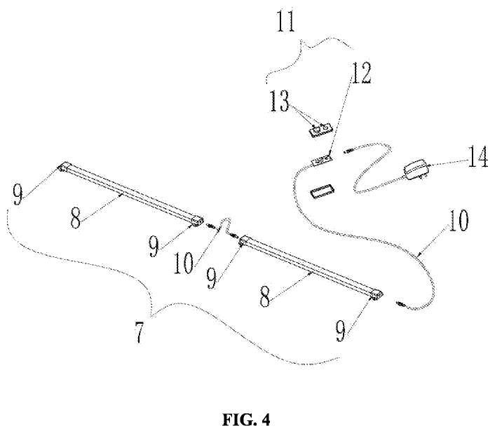

As shown in FIG. 4, the control assembly 11 is provided with a control unit 13. The control unit 13 is connected to the circuit board 12. The control unit 13 controls the circuit board 12 to supply power to the light strip 8.

In the embodiment of the present disclosure, the control assembly 11 includes a button and a knob. The light-emitting color of the light strip 8 is controlled through the button, and the light-emitting brightness of the light strip 8 is controlled through the knob.

As shown in FIG. 1 to FIG. 4, the folding massage table further includes an adapter 14. The adapter 14 may be connected to an external power socket and converts a voltage of an external power supply of 110-230 V into a safe voltage lower than 36 V. The adapter 14 is connected to the circuit board 12 in the control assembly 11 through the wire 10.

In the embodiment of the present disclosure, the adapter 14 supplies power to the circuit board 12 in the control assembly 11 through the wire 10. A user sends an instruction to the circuit board 12 through the control assembly 11. The circuit board 12 supplies power to the light-emitting units 7 through the wire 10. The two light-emitting units 7 are electrically connected through the wire 10, so that the light strips 8 of the two light-emitting units 7 emit light.

The above descriptions are only the preferred embodiments of the present disclosure, and are not intended to limit the present disclosure. Any modifications, equivalent replacements and improvements that are made within the spirit and principle of the present disclosure shall fall within the protection scope of the present disclosure.

What is claimed is:

1. A folding massage table with an atmosphere lamp, comprising:
a rigid planner surface, a cushioned pad, and an upholstery cover, wherein the rigid planner surface is divided into a left rigid planner surface and a right rigid planner surface, and the two rigid planner surfaces are connected through a hinge; the rigid planner surfaces inwards rotate around the hinge and are folded; the cushioned pad is divided into a left part and a right part, and the two cushioned pads are fixedly mounted on the left and right rigid planner surfaces respectively; the upholstery cover is upholstered on the left and right cushioned pads;
the folding massage table further comprises table legs, long leg supports and short leg supports; the table legs are rotatably mounted at end corners of the left rigid planner surface and the right rigid planner surface that are away from each other; one end of each long leg support is rotatably connected to positions of the left and right rigid planner surfaces close to the hinge; the other end of each long leg support is rotatably connected to one short leg support; the other end of each the short leg support is rotatably connected to a lower part of one table leg;
the folding massage table further comprises a cable system; the cable system is provided with multiple mounting points; the left and right mounting points are respectively connected to upper parts of the left and right table legs; the middle mounting points are respectively connected to the joint parts of the short leg supports and long leg supports on the left side and the joint parts of the short leg supports and long leg supports on the right side;
the folding massage table further comprises a light-emitting assembly; and the light-emitting assembly comprises a light-emitting unit, a wire, a control assembly and an adapter.

2. The folding massage table with the atmosphere lamp according to claim 1, wherein at least two light-emitting units are arranged, each of which is at least arranged below each of the left and right rigid planner surfaces; and the light-emitting units emit light when being powered on.

3. The folding massage table with the atmosphere lamp according to claim 1, wherein each light-emitting unit comprises a light strip and a fixing member; the fixing member is fixedly connected to a lower part of the rigid planner surface; and the fixing member clamps the light strip.

4. The folding massage table with the atmosphere lamp according to claim 1, wherein a plurality of light-emitting units are connected through wires, and each wire is a soft wire.

5. The folding massage table with the atmosphere lamp according to claim 3, further comprising a control assembly, wherein a circuit board is mounted inside the control assembly; and the circuit board is connected to the light strip through a wire.

6. The atmosphere lamp for the massage table according to claim 5, wherein the circuit board controls a light-emitting brightness and a light-emitting color of the light strip by means of controlling power supplying.

7. The atmosphere lamp for the massage table according to claim 5, wherein the control assembly is provided with a control unit, and the control unit is connected to the circuit board; and the control unit controls the circuit board to supply power to the light strip.

8. The atmosphere lamp for the massage table according to claim 5, further comprising a power adapter, wherein the power adapter is used for converting a voltage of an external power supply of 110-230 V into a safe voltage lower than 36 V; and the power adapter is connected to the circuit board in the control assembly through a wire.

9. The atmosphere lamp for the massage table according to claim 1, wherein the table legs rotate towards the hinge around joint parts of the table legs and the rigid planner surface; the short leg supports rotate around joint parts of the short leg supports and the table legs; the long leg supports and the short leg supports rotate around joint parts thereof; and the long leg supports rotate around joint parts of the long leg supports and the rigid planner surface.
